(19) United States
(12) Patent Application Publication
(10) Pub. No.: US 2018/0349796 A1
(43) Pub. Date: Dec. 6, 2018

(54) CLASSIFICATION AND QUARANTINE OF DATA THROUGH MACHINE LEARNING

(71) Applicant: Facebook, Inc., Menlo Park, CA (US)

(72) Inventors: Tanton Holt Gibbs, Redmond, WA (US); Li-yen Chen, Medina, WA (US); Robert Charles Boyle, Tacoma, WA (US); Betty Yee Man Cheng, Kirkland, WA (US)

(21) Appl. No.: 15/612,909

(22) Filed: Jun. 2, 2017

(51) Int. Cl. G06N 99/00; H04L 29/06

(52) U.S. Cl. CPC G06N 99/005; H04L 63/104

(57) ABSTRACT

The present disclosure relates to techniques for data classification. The techniques for data classification may include a machine learning (ML)-based classifier for classification of potentially objectionable content and differentiating responses based on a confidence score and classification category outputted by the ML-based classifier.

### BACKGROUND

Online systems, such as social networking systems or other content-sharing systems, receive content from users or third party systems and provide the received content to online system users. The increasing popularity of online systems and the significant amount of user-specific information maintained by online systems allow users of an online system to easily communicate with other users and share content with other users. In the meantime, the amount of objectionable materials posted by users is increasing rapidly as well. A system of manual review may be implemented to determine whether some of the materials should be removed from the online system, based on reported incidents of potentially objectionable content, but such a manual review system does not scale well. As the number of users and amount of content posted by users increase, it is difficult to have enough human reviewers to review the high volume of reported content. As a result, the lag time associated with the review of potentially objectionable content may increase, and a human reviewer may not have sufficient time to review the content to make the right decision. This may lead to the failure to quickly remove objectionable content and/or excessive removal of non-objectionable content, neither of which is desirable.

### SUMMARY

The present disclosure relates to techniques for data classification and determining corresponding actions based on the classification. More specifically, in certain aspects of the present disclosure, a computer-implemented method for limiting access to social network content is provided. The method may include receiving input content posted by a user of a social networking system, and determining a classification category for the input content and an associated confidence score by applying a set of inputs associated with the input content to a trained machine-learning (ML) model. The classification category may be selected from a plurality of classification categories. Upon determining that the classification category for the input content is a particular classification category and the confidence score is within a first range of values, access to the input content by a first set of one or more users of the social networking system may be restricted. Upon determining that the classification category is the particular classification category and the confidence score is within a second range of values that does not overlap with the first range of values, access to the input content by a second set of one or more users of the social networking system may be restricted, where the number of users in the first set of one or more users is different from the number of users in the second set of one or more users.

In certain embodiments of the computer-implemented method for limiting access to social network content, the first set of one or more users may include all users of the social networking system. In some embodiments, the second set of one or more users may include all users of the social networking system other than the user who posted the input content. In some embodiments, the second set of one or more users may include all users of the social networking system other than (a) the user who posted the input content and (b) users associated with the user who posted the input content. In some embodiments, restricting access by the first set of one or more users or the second set of one or more users may include removing the input content from one or more newsfeeds of the first set of one or more users or the second set of one or more users. In some embodiments,

[symbol]

In certain embodiments of the computer-implemented method for limiting access to social network content, access to the input content by the second set of one or more users may be restricted during a manual content review process. In some embodiments, upon completion of the manual content review process, access to the input content by the first set of one or more users may either be restricted or be permitted, depending on an outcome of the manual content review process.

In certain embodiments, the computer-implemented method for limiting access to social network content may further include, upon determining that the classification category is the particular classification category, and during a manual content review process, permitting access, by all users of the social networking system, to the input content upon determining that the confidence score is in a third range of values, where the third range of values does not overlap with the first range of values or the second range of values. In some embodiments, upon completion of the manual content review process, access to the input content by all users of the social networking system may either be restricted or be permitted depending on an outcome of the manual content review process.

In certain embodiments, the input content may include at least one of an image file, a video file, or a link to an image or video file. In some embodiments, the set of inputs provided to the ML model may include the input content or data derived from the input content. In some embodiments, the set of inputs may include activities of one or more users on the social networking system relating to the input content.

In certain embodiments, the computer-implemented method for limiting access to social network content may further include updating the ML model with additional training. In some embodiments, the computer-implemented method may also include determining, by the computer system and by applying the set of inputs or a new set of inputs to the updated ML model, a new classification category for the input content and a new associated confidence score. The computer-implemented method may also include, upon determining that the new classification category is a particular classification category, restricting access by the first set of one or more users or the second set of one or more users to the input content depending on whether the new confidence score is in the first range of values or the second range of values.

In certain embodiments, the computer-implemented method for limiting access to social network content may further include determining, by the computer system and by applying a new set of inputs to the ML model, a new classification category for the input content and a new associated confidence score. The computer-implemented method may also include, upon determining that the new classification category is a particular classification category, restricting access by the first set of one or more users or the second set of one or more users to the input content depending on whether the new confidence score is in the first range of values or the second range of values.

In certain embodiments, a non-transitory computer-readable storage medium storing a plurality of instructions executable by one or more processors is disclosed. The plurality of instructions, when executed by the one or more processors, may cause the one or more processors to receive input content posted by a user of a social networking system, and determine a classification category for the input content and an associated confidence score by applying a set of inputs associated with the input content to a trained machine-learning (ML) model. The classification category may be selected from a plurality of classification categories. Upon determining that the classification category for the input content is a particular classification category and the confidence score is within a first range of values, the plurality of instructions may cause the one or more processors to restrict access to the input content by a first set of one or more users of the social networking system. Upon determining that the classification category is the particular classification category and the confidence score is within a second range of values that does not overlap with the first range of values, the plurality of instructions may cause the one or more processors to restrict access to the input content by a second set of one or more users of the social networking system, where the number of users in the first set of one or more users is different from the number of users in the second set of one or more users.

In certain embodiments of the non-transitory computer-readable storage medium, restricting access to the input content may include initiating a manual content review process for the input content. In some embodiments, the plurality of instructions further cause the one or more processors to, upon determining that the classification category is the particular classification category, restrict access by a third set of one or more users of the social networking system to the input content upon determining that the confidence score is in a third range of values. A number of users in the third set of one or more users of the social networking system is less than the number of users in the second set of one or more users of the social networking system. The third range of values does not overlap with the first range of values and the second range of values. In some embodiments, the second set of one or more users may include connected users associated with the user that posted the input content and does not include the user that posted the input content.

In certain embodiments, a system may include one or more processors and a non-transitory computer-readable medium storing instructions. The instructions, when executed by the one or more processors, may cause the one or more processors to receive input content posted by a user of a social networking system, and determine a classification category for the input content and an associated confidence score by applying a set of inputs associated with the input content to a trained machine-learning (ML) model. The classification category may be selected from a plurality of classification categories. Upon determining that the classification category for the input content is a particular classification category and the confidence score is within a first range of values, the instructions may cause the one or more processors to restrict access to the input content by a first set of one or more users of the social networking system. Upon determining that the classification category is the particular classification category and the confidence score is within a second range of values that does not overlap with the first range of values, the instructions may cause the one or more processors to restrict access to the input content by a second set of one or more users of the social networking system, where the number of users in the first set of one or more users is different from the number of users in the second set of one or more users.

### BRIEF DESCRIPTION OF THE DRAWINGS

Illustrative embodiments are described in detail below with reference to the following figures:

FIG. 1 is a simplified block diagram of a social networking system;

FIG. 2 is a simplified flowchart illustrating an example method for data classification and quarantine, according to certain aspects of the present disclosure;

FIG. 3 is a simplified block diagram illustrating a social network host for implementing some of the examples disclosed herein;

FIG. 4 is a simplified block diagram of an example system for data classification and quarantine, according to certain aspects of the present disclosure; and

FIG. 5 is a simplified block diagram of an example computing system for implementing some of the examples disclosed herein.

### DETAILED DESCRIPTION

In the following description, for the purposes of explanation, specific details are set forth in order to provide a thorough understanding of examples of the disclosure. However, it will be apparent that various examples may be practiced without these specific details. For example, circuits, systems, networks, processes, and other components may be shown as components in block diagram form in order to not obscure the examples in unnecessary detail. In other instances, well-known circuits, processes, algorithms, structures, and techniques may be shown without necessary detail in order to avoid obscuring the examples. The figures and description are not intended to be restrictive.

The ensuing description provides examples only, and is not intended to limit the scope, applicability, or configuration of the disclosure. Rather, the ensuing description of the examples will provide those skilled in the art with an enabling description for implementing an example. It should be understood that various changes may be made in the function and arrangement of elements without departing from the spirit and scope of the disclosure as set forth in the appended claims.

A social networking system is a highly interactive online platform through which individuals, communities, and organizations can create, share, discuss, and modify user-generated content or pre-made content posted online. The user-generate content may include, for example, text posts or comments, digital photos or videos, and data generated through all online interactions. Virtual communities and online networks may be created in the social networking system when a user connects his or her profile with those of other individual users or groups. Connected users may share information with each other, within a group, within a community, or within the whole network, which may include billions of users. Social networking systems are generally enabled by web-based technologies, mobile technologies, and computer technologies, including the Internet, mobile devices, computer servers and data centers, wireless wide-area networks (WWANs), wireless local area networks (WLANs), wireless personal area networks (WPANs), etc.

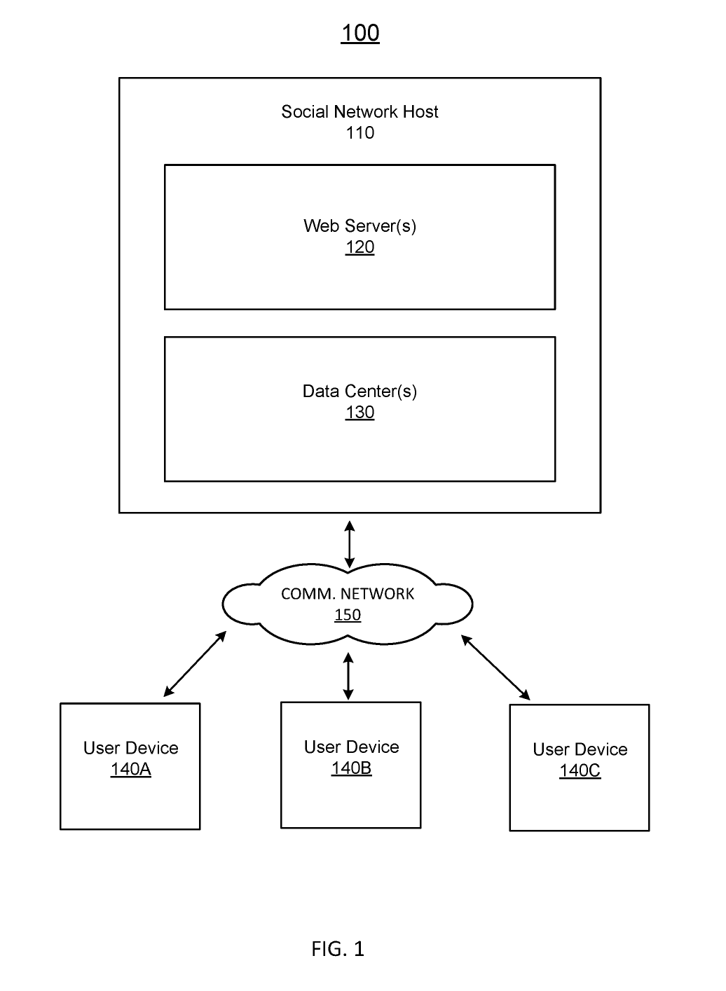

FIG. 1 is a simplified block diagram of a social networking system 100. Social networking system 100 may include a social network host 110 connected to one or more user devices 140A, 140B, and 140C (collectively “140”), through a communication network 150, which may include communication links using technologies such as Ethernet, IEEE 802.11, worldwide interoperability for microwave access (WiMAX), 3G, 4G, 5G, code division multiple access (CDMA), digital subscriber line (DSL), etc.

Social network host 110 may include one or more web servers 120 and one or more data centers 130. Web server(s) 120 may serve web pages, as well as other content, such as JAVA®, FLASH®, XML, and so forth. A user may send a request to, web server(s) 120 to upload information (e.g., images or videos) that may be stored in data center(s) 130. Web server(s) 120 may also receive and route messages, such as instant messages, queued messages (e.g., email), text messages, short message service (SMS) messages, or messages sent using any other suitable messaging technique, between social network host 110 and user devices 140.

Data center(s) 130 may include one or more use profile stores, where a user profile for each user of social networking system 100 may be stored. A user profile may include multiple data fields, each describing one or more attributes of the corresponding user. Data center(s) 130 may also include one or more edge stores that store information regarding connections between users and other objects on the social networking system 100 as edges. Some edges may be defined by users, thus allowing users to specify their relationships with other users. Users may generate edges with other users that parallel the users' real-life relationships, such as family, friends, coworkers, partners, and so forth. For example, a first user may indicate that a second user is a “friend” of the first user or request to add the second user as a friend. In response to this indication or request, social networking system 100 (more specifically, social network host 110) may transmit a “friend request” to the second user. If the second user confirms the “friend request,” social networking system 100 may associate the two users through an edge. The edge may represent, for example, a friendship, a family relationship, a business or employment relationship, a fan relationship, a follower relationship, a visitor relationship, a subscriber relationship, a superior/subordinate relationship, a reciprocal relationship, a non-reciprocal relationship, another suitable type of relationship, or two or more such relationships.

Data center(s) 130 may further include one or more content stores that store objects each representing various types of content. Examples of content represented by an object may include, for example, a page post, a status update, a photograph, a video, a link, a shared content item, a gaming application achievement, a check-in event at a local business, a brand page, or any other type of content. Data center(s) 130 may also include one or more action stores that may be used by social network host 110 to track user actions on social networking system 100. Users may interact with various objects on social networking system 100, and information describing these interactions may be stored in the action stores. Examples of interactions with objects may include, for example, commenting on posts, sharing links, checking-in at physical locations, accessing content items, etc.

Each of the one or more user devices 140 may correspond to a user and may comprise a processor, memory (with volatile memory and/or non-volatile storage drives), input and output interfaces, or other hardware or software known in the art. User device(s) 140 may be used to provide input content to social network host 110 through a network page of social networking system 100 or a user application software (“app”). The input content may be generated by a first user using a first user device (e.g., via a keyboard, camera, etc.), or may be created by a third party and posted by the first user using the first user device (e.g., by downloading, copying, pasting, or sharing a link, etc.) to social networking system 100. The input content posted by the first user may be provided to a newsfeed linked to the profile of the first user and provided to other users that are connected with the first user. The other users may then access the content, post comments, or share the link. Each of these other users may have a corresponding unique profile within social networking system 100.

As described above, an online system, such as a social networking system or other content sharing system, allows a user to establish connections with other users and provide content to the online system, which may then provide the content to the other users connected to the user. In certain cases, the content provided by the user may include objectionable materials according to a set of rules (e.g., community standards identified by the social networking system, etc.), such as, for example, illegal materials, pornographic images or videos, certain violent content, or confidential information. Public scrutiny of objectionable content on social network has surged as social networking system has become a powerful tool for the objectionable content to reach a very large audience.

Current systems for reducing the amount of objectionable content rely heavily on manual review of reported incidents of potentially objectionable content. When a potentially objectionable content is reported by, for example, another user, a human reviewer may review the reported potentially objectionable content (e.g., pornographic materials) and determine whether the content should be removed from the social networking system based on a set of community standards. For example, according to certain community standards, pornographic materials may include content containing nudity or sexual activity, including digitally created content and descriptions of sexual acts that go into vivid detail, unless the content is posted for educational, humorous, or satirical purposes. The human review may take, for example, up to an hour, multiple hours, or even days, depending on the availability of the human reviewer. As the number of users and the amount of content posted by the users increase, it may be difficult to have enough human reviewers to review the high volume of reported content in a timely manner. Furthermore, in many cases, the potential objectionable content may have been widely accessed before it is reported. As such, removing the content from the social networking system after it is reported and based on human review may not remedy the damages caused by the potential objectionable content. On the other hand, removing content that may be mistakenly identified as objectionable from the social media may also cause controversy and public concerns.

Machine-learning (ML) or artificial intelligence (AI)-based techniques may be used to flag and/or remove potential objectionable content. However, simply applying ML-based techniques to produce a classification, without more, may result in unacceptable rates of misses or false alarms. As such, in many situations, actions taken based on the classification alone often lead to failure to remove certain objectionable content or removal of non-objectionable content.

Disclosed herein are ML-based techniques for classifying potentially objectionable content and controlling the accessibility of the content by different groups of users based on the classification results that include the corresponding confidence score. More specifically, in certain embodiments, when a social network host receives input content posted by a user of a social networking system, the social network host may determine a classification category and an associated confidence score for the input content by applying one or more machine-learning techniques to the input content and /or information associated with the input content. If it is determined that the classification category is a particular classification category, for example, “objectionable” or “pornographic,” the social network host may then determine a tiered accessibility of the content by different groups of user based on the confidence score, as described in detail below.

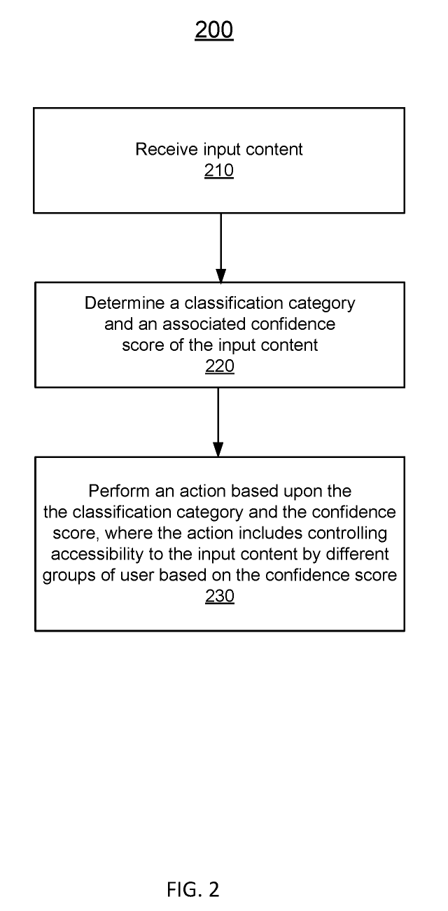

FIG. 2 is a simplified flowchart illustrating an example method of data classification and quarantine, according to certain aspects of the present disclosure. At 210, input content may be received by a social network host (e.g., social network host 110), for example, from a user device 140 via a communication network 130. The input content may comprise, for example, an image file, a uniform resource locator (URL) with an image, a video file, or text.

At 220, a classification category and an associated confidence score may be determined for the input content by the social network host. The classification categories may include two or more discrete categories, such as, for example, “objectionable, or “non-objectionable.” The confidence score may indicate the probability that the input content belongs to the classification category, such as, for example, 60%, 70%, 80%, 90%, etc. For example, the social network host may determine the classification category for the input content from a plurality of classification categories. Each of the plurality of classification categories may correspond with one or more actions to perform with the input content. In some examples, determining the classification category and the associated confidence score may be performed by applying one or more machine-learning (ML) techniques to a set of inputs including the input content and other information associated with the input content. For example, one or more supervised or unsupervised machine learning techniques, such as Naive Bayes, Neural Networks, Support Vector Machines (SVM), and k-Nearest Neighbor (KNN), may be used to generate a characterization or classification model using a set of training data that includes, for example, input content with corresponding classification category as identified or labeled by manual review. The characterization model may include, for example, a set of features, policies, and the corresponding weights for making decisions. The characterization model may then be applied to the set of inputs associated with the newly received input content.

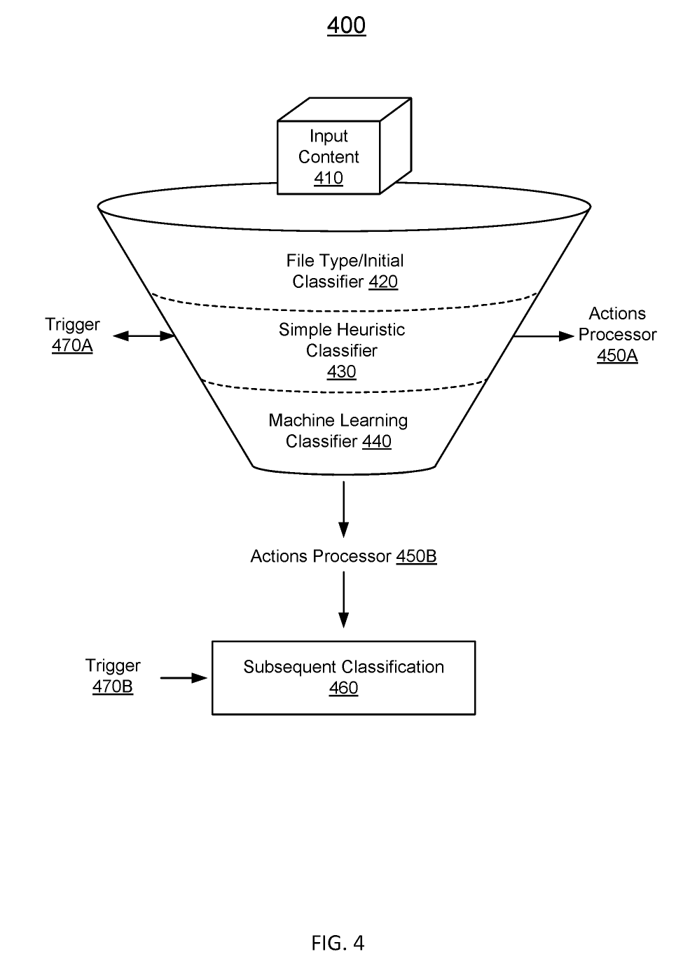

In some implementations, two or more classification processes may be performed for the input content. For example, the first classification process may comprise a simple heuristic classifier. The simple heuristic classifier may invoke a trained/structured ML-based technique that uses a subset of the set of inputs to determine a classification category and associated confidence score for the input content. For example, when the confidence score associated with the input content indicates that the probability that the input content is objectionable exceeds a threshold, the input content may not be accessible to users in the social networking system. When the confidence score does not exceed the threshold, the classification process may proceed to a second ML-based classification technique that may use more or all inputs of the set of inputs to determine the classification category and the associated confidence score. The multi-step classification process is described in more detail with respect to FIG. 4 below.

At 230, upon determining the classification category and associated confidence score, an action may be selected and performed based on the classification category and the confidence score, where the action may include providing tiered accessibility to the input content by different groups of user based on the confidence score. For example, upon determining that the classification category is a particular classification category, such as “objectionable,” the social network host may restrict access to the input content by one or more groups of users, based on the confidence score associated with the classification category.

In some implementations, when the confidence score is within a first range of values, the social network host may restrict access to the content by a first set of one or more users of the social networking system. When the confidence score is within a second range of values, the social network host may restrict access to the content by a second set of one or more users of the social networking system. The number of users in the first set of one or more users may be more than a number of users in the second set of one or more users. The second range of values may not overlap with the first range of values. When the confidence score is in a third range of values, the social network host may restrict access to the content by a third set of one or more users of the social networking system. The number of users in the third set of one or more users may be fewer than a number of users in the second set of one or more users, and in some cases, may be zero (i.e., permitting access to content by all users). The third range of values may not overlap with the first range of values and the second range of values. In some examples, the first set of one or more users of the social networking system may include the user that posted the content to the social networking system, while the second set of one or more users may not include the user that posted the content (i.e., the user that posted the content is not restricted and may have access to the content). In some implementations, more ranges of values for the confidence score and corresponding actions may be used.

More specifically, in one example, if the confidence score is within a first range of values and indicating that the input content is most likely to be objectionable, the action may be to immediately remove the input content from the social networking system such that no user (except the system administrator) within a communication system (e.g., social networking system) may have access to the content.

If the confidence score is within a second range of values lower than the first range of value, and thus the input content less likely to be objectionable but still have a high probability of being objectionable, the action might be to temporarily remove accessibility to the content (e.g., “quarantine” the data) while carrying out a secondary classification process (e.g., human review). The outcome of the secondary classification process can determine the next step after the quarantine (e.g., removal or made available) and may be completed in a reasonable amount of time (e.g., 1 hour). During the secondary classification process, the content may only be accessible by a limited set of user(s), e.g., only the user who posted the content. Such a “quarantine” may minimize the impact of the ML-based classification when the classification is not made with a high confidence level. Because the user who posted the content may still be able to access the content, he or she would be less likely to negatively react if he or she does not see that the content is removed.

Various other actions based on other ranges of confidence score may be implemented as well to restrict access to the content by various users or various groups of user. For example, at an even lower confidence score, or within a third range of confidence values that is lower than he second range of values, the action taken might be to not quarantine the content (e.g., making it available to the user that posted the content and at least some, or even all, users that are connected to the posting user), but still carry out the secondary classification process (e.g., human review). Other tiers of confidence score and corresponding actions (e.g., content accessible to different groups of user) are also possible. In some implementations, the content may not be removed or the access to the content may not be restricted, but the content may have a lower priority for sharing.

The method described above with respect to FIG. 2 may be perform by a social network host, such as a server that may perform a machine learning-based characterization or classification, and may determine and perform corresponding actions as described below.

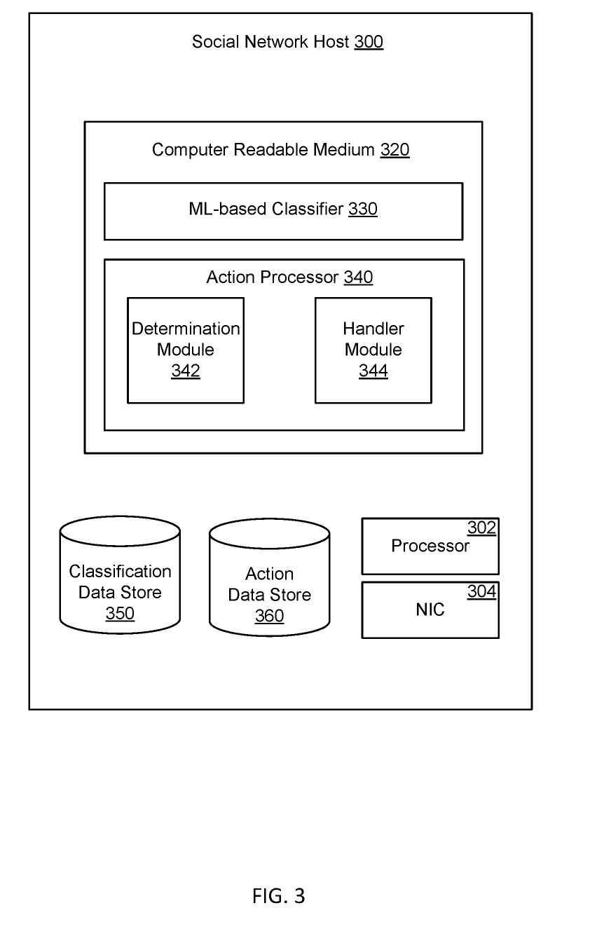

FIG. 3 is a simplified block diagram illustrating a social network host 300 for implementing some of the examples disclosed herein. Social network host 300 may include one or more processors 302, a network interface card (NIC) 304, and computer readable medium 320 that stores a ML-based classifier 330 and action processor 340, and one or more data stores including, for example, a classification data store 350 and an action data store 360.

Processor(s) 302 may include any suitable processing device or any combination of such devices. An exemplary processor may comprise one or more microprocessors working together to accomplish a desired function. The processor may include a central processing unit (CPU) that comprises at least one high-speed data processor adequate to execute program components for executing user and/or system-generated requests.

NIC 304 may provide a communication interface from social network host 300 to user devices via one or more communication networks, including local area networks (LANs), wide area networks (WANs) (e.g., the Internet), and various wireless telecommunications networks. NIC 304 may comprise Ethernet cards, Asynchronous Transfer Mode NICs, Token Ring NICs, wireless network interface controllers (WNICs), wireless network adapters, and the like. NIC 304 may facilitate transmission and receipt of the input content to the social networking system.

Computer readable medium 320 may be any suitable device or devices that can store electronic data. A computer readable medium may be embodied by one or more memory devices, including a working memory, which may include a random access memory (RAM) or read-only memory (ROM) device. Examples of memory devices may include memory chips, disk drives, etc. Such memory devices may operate using any suitable electrical, optical, and/or magnetic mode of operation. Computer readable medium 320 may comprise a non-transitory computer-readable storage medium that stores a plurality of instructions executable by one or more processors 302. The plurality of instructions, when executed by one or more processors 302, may cause one or more processors 302 to perform any of the methods described herein.

Social network host 300 may include ML-based classifier 330 stored in computer readable medium 320 and may be loaded to a memory (e.g., a RAM such as synchronous dynamic random-access memory (SDRAM)) during run time. ML-based classifier 330 may determine a classification category for the input content using a classification or characterization model previously trained using a training data set, which may be from the results of manual review. The classification or characterization of the input data may be based on a set of inputs (e.g., features) including content features (e.g., features intrinsic to the content) and/or social networking features (e.g., features extrinsic to the content, such as behavioral features of the posting user or users that review the content and/or post comments on the content).

Content features may include attributes of the input content that may have a close correlation with the classification category or may be the most distinguishing features that can be used to differentiate content of different categories, such as objectionable materials and non-objectionable materials. In an illustrative example, social network host may receive visual input content and initiate an image recognition process. The image recognition process may extract certain features from the input content. The features may be determined during the training or learning process as having a close correlation with the classification category or being the most distinguishing features that can be used to differentiate content of different categories.

Content features of the input content may be text features as well, where the text features may be determined during the training to at least partially correlate with certain attributes of a known classification category. In an illustrative example, social network host may receive input content and initiate an optical character recognition (OCR) process or, alternatively, analyze the text by parsing the text to identify individual terms. The OCR processing or analysis may determine whether the input content includes certain text that correlates with a particular classification.

The set of inputs may also comprise features extrinsic to the actual content, such as behavioral features. Behavioral features may include, for example, an attribute of a user associated with a known classification category. In an illustrative example, the social network host may have received first input content that is classified as objectionable from a first user. Any second input content from the first user may have an increased likelihood as being objectionable as well. Thus, the attribute of the user that posted the content may also be a useful input for classifying the content.

Other behavioral features may be associated with the past behavior of users that interact with input content. For example, a user may have interacted with first input content (e.g., like, comment, share, etc.) that is identified as in a particular classification category. When the user interacts with second input content, the second input content may have an increased likelihood as being in the same particular classification category as the first input content.

An aggregate of behavioral features may be used to identify a classification category as well. For example, a first user and a second user may provide the same input content to the social networking system, even though no connection is identified between the two users and therefore it is unlikely that one of the first and second users copied the content from the other one's post. This may indicate that that the content may be from a source that both users frequently visit, which may happen to be a pornographic site. Shared attributes of different users may also correlate with the content. For example, if both users have shared content of the same classification category (e.g., objectionable content) before, the new input content posted by both users is more likely to be in the same classification category of objectionable content as well.

All these extracted intrinsic and extrinsic features may be used as inputs to the classifier to characterize or classify the content using the pre-trained model. For example, ML-based classification may be performed using these or other signals associated with content features and/or behavioral features. In some examples, the ML-based classification may be preceded by a simple heuristic classifier. For example, the classification process may receive input content and analyze the input content using the simple heuristic classifier first. When the classification category and confidence score are within a certain range of values, the input content may be forwarded to a second classification process involving the ML-based classification. This alternative classification process that utilizes at least two levels of classification, including a simple heuristic classifier and the ML-based classifier, is described below in detail with respect to FIG. 4.

The machine-learning (ML) based classifier 330 may also provide an associated confidence score. The confidence score may identify the likelihood that the input content corresponds with a particular classification category. A number of inputs associated with a particular classification category may determine the confidence score that the input content is associated with that classification category.

The classification category and associated confidence score may be transmitted to the action processor 340, as illustrated in FIG. 3. Action processor 340 may comprise a determination module 342 and one or more handler module(s) 344.

Determination module 342 of action processor 340 may determine an action for the input content based at least in part on the classification category and associated confidence score. Determination module 342 may determine an action to perform from a plurality of actions, where each action may provide a different level of access to the input content by one or more users of the social networking system. Determination module 342 may determine to restrict access, remove, or delete the input content from a user's newsfeed, such that the input content may become inaccessible. In one example, determination module 342 may restrict access by one or more users to the input content. In another example, determination module 342 may delete the input content from the newsfeed of one or more users when the classification category of the input content corresponds with a particular classification category.

The action may be determined based at least in part on a range of values of the confidence score. For example, when the confidence score is in a first range of values, determination module 342 may determine to restrict access by a first set of one or more users of the social networking system to the input content. This may include restricting access to only a system administrator and/or restricting access so that no users of the social networking system have access to the input content. Other sets of users may be identified without diverting from the scope of the disclosure.

If the confidence score is within a second range of values, determination module 342 may restrict access by temporarily removing accessibility to the image (e.g., “quarantine” the data) by a second set of one or more users while determination module 342 or other module may carry out a secondary classification process (e.g., human review). During quarantine, accessibility to the input content and review of the input content may be affected. For example, the accessibility to the input content may be restricted to only permit access to the input content by the user that posted the content. In some examples, the system may perform a secondary classification process of the input content during quarantine. The secondary classification process may comprise transmitting the input content to a human reviewer, where the human reviewer may analyze the input content to determine whether any attributes of the input content are objectionable in comparison with the community standards. The secondary classification process may determine one or more actions, including removing access by all users of the social networking system to the input content, allowing access to the input content by all users with a connection to the user that posted the input content, or deleting the input content from the social networking system. In some examples, the input content provided to and the corresponding results from the secondary classification process may be used to train the ML-based classifier and improve the prediction function for future input content.

At an even lower confidence score, or within a third range of values, determination module 342 may not quarantine the input content (e.g., make it available), but may still carry out the secondary classification process. In some examples, the action to take for the input content with associated confidence score within the third range of values may include limiting access to the input content to users that share a common characteristic with the user that posted the input content, but removing accessibility by users that do not share the characteristic with the user that posted the input content.

Determination module 342 may determine the action for each of the ranges of values. The ranges of values may not overlap, so that a single action is performed for the input content associated with a confidence score.

After determination module 342 determines the action, action processor 340 may initiate handler module 344 to invoke the action determined by determination module 342. handler module 344 may include one or more action handlers. In some examples, a single action handler may be used to perform a single series of actions, and multiple action handlers may be used to invoke the desired actions. For example, a first action handler may be implemented to restrict input content according to a first range of values. This may restrict access by a first set of one or more users (e.g., only permitting a system administrator, etc.) to the input content. In some examples, the first action handler may identify a newsfeed for the user that posted the input content (e.g., by an identifier stored in the user profile, etc.) and remove access to the content by the user's newsfeed.

A second action handler may restrict access by a second set of one or more users according to a different range of values than the first range of values. For example, the second handler may add the input content to the newsfeed of the user that posted the content by the second action handler (e.g., if the content was previously removed or awaiting the determination by determination module 342) and may also remove the input content from the newsfeeds of other users connected with the user. In another example, the second action handler may restrict access to only the user that posted the input content but none of the connected users, or any other iteration of users.

In some examples, handler module 344 may identify a newsfeed for the user that posted the input content (e.g., by an identifier stored in the user profile, etc.) to help identify and remove access to input content on newsfeeds associated with one or more users. In some examples, the input content may be added to the newsfeed of the user by a particular action handler (e.g., if the content was previously removed or awaiting the determination by determination module 342) and removed from the newsfeed by a different action handler. A second action handler may be used to restrict the input content to a subset of connected users of the user that posted different input content to the social networking system that shares an attribute with the input content. Different action handlers may identify different sets of users according to the confidence score and the ranges of values and/or perform different actions to adjust the accessibility of the input content. In some examples, a third action handler may be implemented to remove the input content from quarantine or allow access to the input content in one or more newsfeeds after the completion of a secondary classification process (e.g., human review).

A person skilled in the art may interpret this non-limiting description as including one or more action handlers. For example, a number of action handlers may not be limited to only three action handlers as provided in the illustration. Action handlers may be added and removed (e.g., pluggable) with the social network host.

Once the access to the input content is restricted, a subset of users of the social networking system may not receive the input content on a newsfeed of the social networking system. Instead, the newsfeed for these users may comprise other input content that has been identified as corresponding with a different classification category (e.g., that is not identified as “objectionable” in classification data store 350) and/or associated with a confidence score within a different range of values. For example, a confidence score corresponding with twenty-five percent for an objectionable classification category may correlate to no restriction by determination module 342.

Classification data store 350 may comprise data and correlations with classification categories and the set of inputs or attributes. For example, classification data store 350 may identify one or more attributes of input content that are known to correlate with a particular classification. When the new input content includes certain attributes of a classification category in classification data store 350, the ML-based classifier may determine that the new input content is also correlated with that classification category.

Action data store 360 may comprise one or more actions to perform based at least in part on a particular classification category or confidence score. Action data store 360 may comprise ranges of values, so that when the confidence score is within a range of values, the action that corresponds with the range of values may be performed. Different actions may be performed for different classification categories. For example, action data store 360 may identify that a classification category of “objectionable” with a confidence score of “99.6%” may correspond with an action of “restrict access to remove user that posted content and all connected users.”

As described above, in various implementations, a multi-step classification process may be performed to classify the input content. In some implementations, the multi-step classification process may be performed by a multi-layer classifier. For example, in some implementations, the multi-layer classifier may include different classifiers at different layers, where each classifier may take a different set of inputs. In some implementations, the multi-layer classifier may include one classifier, and different sets of inputs (e.g., initial inputs and updated inputs) may be applied to the classifier at different stages.

FIG. 4 is a simplified block diagram of an example classification system 400 for data classification and quarantine, according to certain aspects of the present disclosure. The classification system 400 may comprise one or more classifiers that are first trained with a training set of input content (e.g., input content identified as objectionable based on manual review) and later invoked by a social network host, such as social network host 300, to classify new input content according to the trained classifications.

The classifier may initiate a trained/supervised machine learning process or untrained/unsupervised machine learning process. With supervised machine learning, the social network host may be trained using a plurality of inputs. First, the social network host may provide input content and initiate an image recognition process, OCR, text analysis, etc. for the input content. Results from this processing may be stored as attributes of the input content. The attributes may also correspond with the content features and behavioral features discussed above with respect to FIG. 3. Additional inputs may be provided with the set of inputs outside of the image recognition process, OCR, and text analysis process without diverting from the scope of the disclosure.

The social network host may generate a prediction function using the attributes as a set of inputs to the function. During the training phase, a first set of inputs may be used to generate a first prediction function, which may output a predicted classification category and/or confidence score. A second set of inputs may be used to adjust the prediction function, and predict a confidence score for the classification category that may be more accurate than the first prediction function in determining the correct classification category and confidence score for the input content. This process may be repeated to generate a function that is as accurate as possible in the prediction of classification category and/or confidence score (e.g., in comparison with a human determination of a classification category and/or confidence score, etc.).

In some cases, the social network host may identify objectionable content without a supervised training. Examples throughout the disclosure may use a trained/supervised machine learning technique, but should not be understood as restricting the ML-based classifier as only conducting trained/supervised machine learning.

With either supervised or unsupervised classifiers, the social network host may determine a function that, when supplied with new input content corresponding with attributes, the function can predict the classification category and confidence score of the input content with those variables.

After the classifier is trained, input content 410 may be received in classification system 400. Input content 410 may comprise various file types (e.g., images, video, audio, etc.), text, URL, and the like that is posted by a user to a social networking system.

Classification system 400 may comprise an initial classifier 420. Initial classifier 420 may receive input content 410 and determine a file type of input content 410. When initial classifier 420 determines a file type of the input content that matches a file type in a subset of file types, the input content may be determined safe (e.g., non-objectionable classification category with a confidence score above a threshold, etc.). This input content may be removed from classification according to classification system 400.

As a sample illustration, the file type for the input content may include text without images (e.g., *.txt file, a string of characters posted as a status update by the user, etc.). This file type may match known file types that do not correspond with at least some of the classification categories of objectionable content according to the community standards (e.g., pornography, violent videos, etc.). As such, classification system 400 may not restrict access to the input content based at least in part on the file type of the input content. When the file type does not match a file type in a subset of file types, classification system 400 may proceed to further classify the input content using a simple heuristic classifier 430.

The simple heuristic classifier 430 may determine a first classification category and associated confidence score of the input content using a subset of inputs. The subset of inputs may be fewer than the set of inputs used by a second classification that implements the machine-learning (ML) technique (e.g., hundreds or thousands of content features or behavioral features may be utilized in the second classification, whereas, for example, six content features or behavioral features may be utilized in the first classification, etc.). The subset of inputs, for example, may include historical actions of the user in association with posting content of a particular classification category and whether the input content matches any previous input content with which the social network host previous restricted access.

After simple heuristic classifier 430, input content 410 may be provided to the social networking system via one or more newsfeeds, or further analyzed to determine whether access to input content 410 should be restricted. In some examples, input content 410 would be analyzed by machine learning classifier 440. Machine learning classifier 440 may determine a second classification category and associated confidence score of the input content using a set of inputs. This process may be similar to the classification process discussed above with respect to FIG. 3.

Once a classification category and associated confidence score are determined, actions processor 450 may determine an action for the input content based at least in part on the classification category and associated confidence score (e.g., using determination module 342) and invoke the action (e.g., using the one or more action handlers 344). Actions processor 450 may determine an action for the input content at any point of the classification process, based at least in part on the determined classification category and associated confidence score. For example, actions processor 450A may determine an action for the input content after the input content has been classified by simple heuristic classifier 430. Actions processor 450B may determine an action for the input content after the input content has been classified by machine learning classifier 440.

The confidence score may change over time using a subsequent classification 460. In a simplistic example, an initial confidence score may identify that input content 410 is one-hundred percent likely to correspond with a particular classification category because the user that posted the input content is only associated with one classification category in a user profile. In some examples, classification system 400 may allow access to input content 410 based at least in part on this initial classification category and associated confidence score. Additional content features or behavioral features may be received for input content 410, including interactions with input content 410 by other users. When other users interact with the input content, the attributes associated with those users may alter the confidence score to correspond with different classification categories or a lower likelihood that the input content corresponds with the particular classification category of the posting user. An updated confidence score for the input content may be determined by the classification system. Subsequent classification 460 may comprise a simple heuristic classifier 430 and/or machine learning classifier 440 to process input content 410 after the initial classification category and associated confidence score, in order to determine an updated classification category and/or updated confidence score.

In some examples, the updated classification category and/or updated confidence score may cause actions processor 450 to adjust the access to the input content. For example, the initial confidence score may correspond with a first range of values and the updated confidence score may correspond with a second range of values. The actions corresponding with these two ranges of values may be different, so that when the input content corresponds with the first range of values, the accessibility of the input content may also be different than when the input content corresponds with the second range of values. This adjustment of accessibility may also restrict access to the input content to a different set of users of the social networking system than an initial set of users of the social networking system that received the input content in their newsfeeds.

A trigger may initiate a classification or calculation (e.g., using a trigger 470A) of the confidence score, or a reclassification or recalculation (e.g., using a trigger 470B) of the confidence score to generate an updated confidence score. For example, input content 410 may correspond with an initial classification category and associated confidence score. Additional content features and/or behavioral features may be received (e.g., an interaction with the content, the user provides content that only corresponds with one classification category, the content is later decided to correspond with a different classification category, etc.). When received, these features may trigger an initiation of simple heuristic classifier 430 and/or machine learning classifier 440 to reclassify input content 410 with the new set of inputs.

In some examples, different inputs may be implemented for different classification categories. For example, a first subset of inputs may correspond with a first file type (e.g., text) and a second set of inputs may correspond with a second file type (e.g., images or video, etc.). The prediction function may vary for each classification category as well. Additionally, different inputs may be implemented at various timeframes throughout the analysis process, which may determine a first prediction function for input content that is provided within a first timeframe (e.g., within one minute of posting the content, etc.) and a second prediction function for input content that is provided within a second timeframe (e.g., within one day of posting the content, etc.). An updated classification category and updated confidence score may be determined from the different set of inputs and/or classification process.

Although particular data distribution techniques are described herein for purposes of illustration, one of ordinary skill in the art will recognize that data distribution may be performed or restricted in other manners as well.

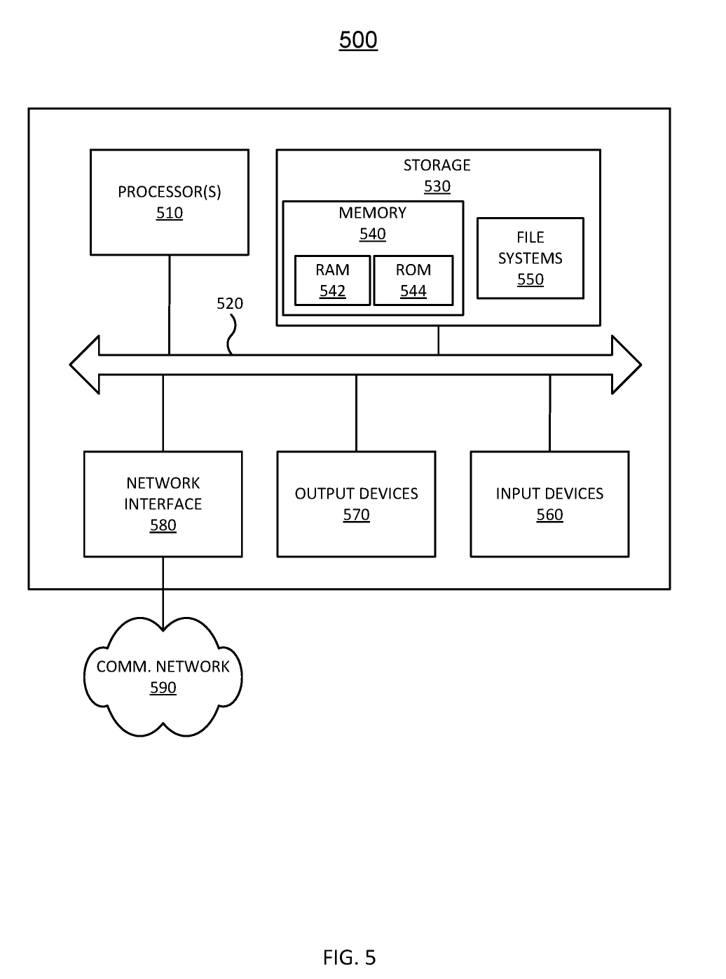

FIG. 5 illustrates an example of a block diagram of a computing system. The computing system shown in FIG. 5 can be used to implement any computing device described herein in replacement of or to supplement to the descriptions provided. In this example, computing system 500 includes processor 510, bus 520, storage 530, memory 540, random access memory (RAM) 542, read-only memory (ROM) 544, file systems 550, user input device 560, output devices 570, network interface 580, and communication network 590. In the present example, user input device 560 is typically embodied as a computer mouse, a trackball, a track pad, a joystick, wireless remote, drawing tablet, voice command system, eye tracking system, and the like. User input device 560 typically allows a user to select objects, icons, text and the like that appear on output devices 570 via a command such as a click of a button or the like. Output devices 570 may include a screen associated with a computing device, virtual reality environment, projection system, speaker, and the like.

Examples of network interfaces 580 typically include an Ethernet card, a modem (telephone, satellite, cable, Integrated Services Digital Network (ISDN)), an asynchronous digital subscriber line (DSL) unit, FireWire® interface, universal serial bus (USB) interface, and the like. For example, network interfaces 580 may be coupled to communication network 590, to a FireWire® bus, or the like. In other embodiments, network interfaces 580 may be physically integrated on the processor 510, may be a software program, such as soft Digital Subscriber Line (DSL), or the like.

In various examples, computing system 500 typically includes familiar computer components such as processor 510 and memory 540 devices, such as RAM 542, ROM 544, file systems 550, and system bus 520 interconnecting the above components.

RAM 542 and ROM 544 are examples of tangible, non-transitory media configured to store data such as embodiments of the present disclosure, including executable computer code, human readable code, or the like. Other types of tangible media include floppy disks, removable hard disks, optical storage media such as CD-ROMS, DVDs and bar codes, semiconductor memories such as flash memories, battery-backed volatile memories, networked storage devices, and the like.

In various examples, computing system 500 may also include software that enables communications over a network such as Hypertext Transfer Protocol (HTTP), Transmission Control Protocol/Internet Protocol (TCP/IP), Real-Time Streaming Protocol (RTP/RTSP), and the like. In alternative embodiments of the present disclosure, other communications software and transfer protocols may also be used, for example Internetwork Packet Exchange (IPX), User Datagram Protocol (UDP), or the like.

Although specific embodiments have been described, various modifications, alterations, alternative constructions, and equivalents are possible. Embodiments are not restricted to operation within certain specific data processing environments, but are free to operate within a plurality of data processing environments. Additionally, although certain embodiments have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described embodiments may be used individually or jointly.

Also, it is noted that individual examples may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable storage medium” or “computer-readable storage medium” includes, but is not limited to, portable or non-portable storage devices, optical storage devices, and various other mediums capable of storing, containing, or carrying instruction(s) and/or data. A machine-readable storage medium or computer-readable storage medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements.

Furthermore, examples may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a machine-readable medium. One or more processors may execute the software, firmware, middleware, microcode, the program code, or code segments to perform the necessary tasks.

Systems depicted in some of the figures may be provided in various configurations. In some examples, the systems may be configured as a distributed system where one or more components of the system are distributed across one or more networks such as in a cloud computing system.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented as a computer program product containing computer program code or instructions executable by one or more processors for performing any or all of the steps, operations, or processes described in this disclosure, where the computer program may be stored on a non-transitory computer readable medium. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of other embodiments. Rather, the preceding description of the embodiments will provide those skilled in the art with an enabling description for implementing various embodiments. Various changes may be made in the function and arrangement of elements.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A computer-implemented method for limiting access to social network content, the method comprising:
receiving, by a computer system, input content posted by a user of a social networking system;
determining, by the computer system, a classification category for the input content and an associated confidence score, wherein the classification category is selected from a plurality of classification categories, and wherein determining the classification category and the associated confidence score comprises applying a set of inputs associated with the input content to a trained machine-learning (ML) model;
upon determining that the classification category is a particular classification category:
restricting access, by a first set of one or more users of the social networking system, to the input content upon determining that the confidence score is in a first range of values; and
restricting access, by a second set of one or more users of the social networking system, to the input content upon determining that the confidence score is in a second range of values, wherein a number of users in the first set of one or more users of the social networking system is greater than a number of users in the second set of one or more users of the social networking system, and wherein the second range of values does not overlap with the first range of values.

2. The method of claim 1, wherein the first set of one or more users comprises all users of the social networking system.

3. The method of claim 1, wherein the second set of one or more users comprises all users of the social networking system other than the user who posted the input content.

4. The method of claim 1, wherein the second set of one or more users comprises all users of the social networking system other than (a) the user who posted the input content and (b) users associated with the user who posted the input content.

5. The method of claim 1, wherein access to the input content, by the second set of one or more users, is restricted during a manual content review process.

6. The method of claim 5, wherein upon completion of the manual content review process, access to the input content by the first set of one or more users is either restricted or permitted depending on an outcome of the manual content review process.

7. The method of claim 1, further comprising:
upon determining that the classification category is the particular classification category, and during a manual content review process, permitting access, by all users of the social networking system, to the input content upon determining that the confidence score is in a third range of values, wherein the third range of values does not overlap with the first range of values or the second range of values.

8. The method of claim 7, wherein upon completion of the manual content review process, access to the input content by all users of the social networking system is either restricted or permitted depending on an outcome of the manual content review process.

9. The method of claim 1, wherein restricting access by the first set of one or more users or the second set of one or more users comprises removing the input content from one or more newsfeeds of the first set of one or more users or the second set of one or more users.

10. The method of claim 1, wherein the input content comprises at least one of an image file, a video file, or a link to an image or video file.

11. The method of claim 1, wherein the set of inputs provided to the ML model comprises the input content or data derived from the input content.

12. The method of claim 1, wherein the set of inputs comprises at least one of:
historical actions of the user in association with posting content of the particular classification category;
whether the input content is similar to or matches any previous input content that has been determined to be in the particular classification category;
whether the input content is similar to or matches any content that is posted by a user who has posted content in the particular classification category; or
historical actions in association with content of the particular classification category by a user that reviews the input content or posts a comment on the input content.

13. The method of claim 1, further comprising:
triggering, upon receiving a new input associated with the input content, determination of a new classification category for the input content and a new associated confidence score based at least in part on the new input.

14. The method of claim 13, further comprising:
upon determining that the new classification category is the particular classification category, restricting access, by the first set of one or more users or the second set of one or more users of the social networking system, to the input content depending on whether the new confidence score is in the first range of values or the second range of values.

15. The method of claim 1, wherein the ML model is trained using a set of input content and corresponding classification categories determined by a manual content review process.

16. A non-transitory computer-readable storage medium storing a plurality of instructions executable by one or more processors, the plurality of instructions, when executed by the one or more processors, cause the one or more processors to:
receive input content posted by a user of a social networking system;
determine a classification category for the input content and an associated confidence score, wherein the classification category is selected from a plurality of classification categories, and wherein determining the classification category and the associated confidence score comprises applying a set of inputs associated with the input content to a trained machine-learning (ML) model; and
upon determining that the classification category is a particular classification category:
restrict access, by a first set of one or more users of the social networking system, to the input content upon determining that the confidence score is in a first range of values; and
restrict access, by a second set of one or more users of the social networking system, to the input content upon determining that the confidence score is in a second range of values, wherein a number of users in the first set of one or more users of the social networking system is greater than a number of users in the second set of one or more users of the social networking system, and wherein the second range of values does not overlap with the first range of values.

17. The computer-readable storage medium of claim 16, wherein restricting access to the input content comprises initiating a manual content review process for the input content.

18. The computer-readable storage medium of claim 16, wherein the plurality of instructions further cause the one or more processors to, upon determining that the classification category is the particular classification category,
restrict access, by a third set of one or more users of the social networking system, to the input content upon determining that the confidence score is in a third range of values, wherein a number of users in the third set of one or more users of the social networking system is less than the number of users in the second set of one or more users of the social networking system, and wherein the third range of values does not overlap with the first range of values and the second range of values.

19. The computer-readable storage medium of claim 16, wherein the second set of one or more users comprises connected users associated with the user that posted the input content and does not comprise the user that posted the input content.

20. A system comprising:
one or more processors; and
a non-transitory computer-readable medium storing instructions that, when executed by the one or more processors, cause the one or more processors to perform operations including:
receiving input content posted by a user of a social networking system;
determining a classification category for the input content and an associated confidence score, wherein the classification category is selected from a plurality of classification categories, and wherein determining the classification category and the associated confidence score comprises applying a set of inputs associated with the input content to a trained machine-learning (ML) model; and
upon determining that the classification category is a particular classification category:
restricting access, by a first set of one or more users of the social networking system, to the input content upon determining that the confidence score is in a first range of values; and
restricting access, by a second set of one or more users of the social networking system, to the input content upon determining that the confidence score is in a second range of values, wherein a number of users in the first set of one or more users of the social networking system is greater than a number of users in the second set of one or more users of the social networking system, and wherein the second range of values does not overlap with the first range of values.
